(19) United States
(12) Patent Application Publication
(10) Pub. No.: US 2025/0067381 A1
(43) Pub. Date: Feb. 27, 2025

(54) REMOVING SCALE FROM A PIPELINE

(71) Applicant: Saudi Arabian Oil Company, Dhahran (SA)

(72) Inventors: Anton Manakhov, Moscow (RU); Tao Chen, Dhahran (SA)

(21) Appl. No.: 18/452,933

(22) Filed: Aug. 21, 2023

(51) Int. Cl. F16L 55/30; B08B 9/051

(52) U.S. Cl. CPC F16L 55/30; B08B 9/051; F16L 2101/12

(57) ABSTRACT

An autonomous robot for descaling a pipeline includes a streamlined housing; a propulsion system at least partially enclosed in the streamlined housing and including a power source and a motor, where the propulsion system is configured to move the housing through a pipeline that includes scale; a flow turbine coupled to the power source and configured to generate electrical power based on a flow of water in the pipeline through the flow turbine as the housing moved through the liquid in the pipeline; and a scale removal sub-assembly including a plasma tool configured to generate plasma near the scale to remove at least a portion of the scale from an inner surface of the pipeline.

### TECHNICAL FIELD

This disclosure relates to apparatus, systems, and methods for removing scale from a pipeline with an autonomous robot.

### BACKGROUND

The formation of scale has implications for the oil and gas industry, which may result in significant reductions in hydrocarbon production and lead to costly downtime. Common scales encountered in pipelines include carbonate, sulfate, silicates, calcium phosphate, and alumina silicates. The prevention of scale formation by adding scale inhibitors is the most common solution. However, due to the fluctuation of water compositions and the complexity of this phenomenon, preventing scale formation can be difficult at times. Also, the detection of scale can be very challenging.

### SUMMARY

In an example implementation, a pipeline scale removal system includes a pipeline that carries a liquid and includes scale formed on an inner surface of the pipeline; and at least one autonomous robot configured to move through the liquid in the pipeline. The at least one autonomous robot includes a housing; a propulsion system that includes a power source and a motor, the propulsion system configured to move the housing through the liquid in the pipeline; a flow turbine coupled to the power source and configured to generate electrical power based on a flow of the liquid through the flow turbine as the housing moved through the liquid in the pipeline; and a scale removal sub-assembly including a plasma tool configured to generate plasma near the scale to remove at least a portion of the scale from the inner surface of the pipeline.

In an aspect combinable with the example implementation, the plasma tool includes at least one high voltage electrode.

In another aspect combinable with any of the previous aspects, the at least one high voltage electrode includes a capillary tube electrode.

In another aspect combinable with any of the previous aspects, the at least one high voltage electrode includes an array of a plurality of high voltage electrodes.

In another aspect combinable with any of the previous aspects, the at least one autonomous robot further includes a high voltage generator coupled to the at least one high voltage electrode and the power source.

In another aspect combinable with any of the previous aspects, the plasma tool is configured to generate plasma at a voltage above a breakdown voltage of the scale to generate acoustic wave energy and UV radiation to remove the portion of the scale from the inner surface of the pipeline.

In another aspect combinable with any of the previous aspects, the power source includes a rechargeable battery.

In another example implementation, a method for removing scale includes positioning at least one autonomous robot in a pipeline that carries a liquid and includes scale formed on an inner surface of the pipeline. The at least one autonomous robot includes a housing; a propulsion system that includes a power source and a motor; a flow turbine coupled to the power source and configured to generate electrical power; and a scale removal sub-assembly including a plasma tool configured to generate plasma. The method includes propelling the housing through the liquid in the pipeline with the propulsion system; operating the plasma tool of the scale removal sub-assembly to generate the plasma near the scale; and removing, with the plasma, at least a portion of the scale from the inner surface of the pipeline.

An aspect combinable with the example implementation includes flowing the liquid through the flow turbine; and generating electrical power with the flow turbine based on the flow of the liquid through the flow turbine as the housing is propelled through the liquid in the pipeline.

Another aspect combinable with any of the previous aspects further includes providing the generated electrical power to at least one of the power source or the motor as the housing is propelled through the liquid in the pipeline.

In another aspect combinable with any of the previous aspects, operating the plasma tool includes operating at least one high voltage electrode to remove the portion of the scale.

In another aspect combinable with any of the previous aspects, operating the at least one high voltage electrode includes operating a capillary tube electrode to remove the portion of the scale.

In another aspect combinable with any of the previous aspects, operating the at least one high voltage electrode includes operating an array of high voltage electrodes to remove the portion of the scale.

Another aspect combinable with any of the previous aspects further includes providing power to a high voltage generator of the autonomous robot from the power source; and powering the at least one high voltage electrode with the high voltage generator.

In another aspect combinable with any of the previous aspects, operating the plasma tool includes operating the plasma tool to generate plasma at a voltage above a breakdown voltage of the scale; and based on the voltage above the breakdown voltage of the scale, generating acoustic wave energy and UV radiation to remove the portion of the scale.

In another example implementation, an autonomous robot for descaling a pipeline includes a streamlined housing; a propulsion system at least partially enclosed in the streamlined housing and including a power source and a motor, the propulsion system configured to move the housing through a pipeline that includes scale; a flow turbine coupled to the power source and configured to generate electrical power based on a flow of water in the pipeline through the flow turbine as the housing moved through the liquid in the pipeline; and a scale removal sub-assembly including a plasma tool configured to generate plasma near the scale to remove at least a portion of the scale from an inner surface of the pipeline.

In an aspect combinable with the example implementation, the plasma tool includes at least one high voltage electrode.

In another aspect combinable with any of the previous aspects, the at least one high voltage electrode includes a capillary tube electrode.

In another aspect combinable with any of the previous aspects, the at least one high voltage electrode includes an array of a plurality of high voltage electrodes.

In another aspect combinable with any of the previous aspects, the at least one autonomous robot further includes a high voltage generator coupled to the at least one high voltage electrode and the power source.

In another aspect combinable with any of the previous aspects, the plasma tool is configured to generate plasma at a voltage above a breakdown voltage of the scale to generate acoustic wave energy and UV radiation to remove the portion of the scale from the inner surface of the pipeline.

In another aspect combinable with any of the previous aspects, the power source includes a rechargeable battery.

Implementations of a pipeline scale removal system to the present disclosure may include one or more of the following features. For example, implementations according to the present disclosure can remove scale in situ within a pipeline (such as on an inner surface of the pipeline that is not exposed to the atmosphere or human operators). As another example, implementations according to the present disclosure can remove scale while avoiding a use of toxic gases (for example, SF₆, CF₄) and avoiding expensive equipment that is usually used. Also, implementations according to the present disclosure can operate at high temperatures to remove scale. Further, implementations according to the present disclosure can act autonomously to remove scale in a pipeline. As another example, implementations according to the present disclosure can be more cost efficient without a need for expensive components, chemicals, or other substances for removing scale as compared to conventional techniques.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example implementation of a pipeline scale removal system that includes an autonomous robot according to the present disclosure.

FIG. 2 is a schematic diagram of an example implementation of an autonomous robot operable to removal scale from a pipeline according to the present disclosure.

FIG. 3 is a schematic diagram of a portion of a scale removal assembly of an autonomous robot operable to removal scale from a pipeline according to the present disclosure.

FIG. 4 is a schematic diagram of another example of a scale removal assembly of an autonomous robot operable to removal scale from a pipeline according to the present disclosure.

FIG. 5 is a schematic illustration of an example controller (or control system) for an autonomous robot operable within a pipeline scale removal system according to the present disclosure.

### DETAILED DESCRIPTION

The present disclosure describes example implementations of apparatus, systems, and methods for removing scale (for example, minerals that precipitate out of a liquid and attached to a surface) in a pipeline, such as a pipeline that carries water or some other fluid that can produce scale. In some aspects, one or more autonomous robots (such as an unmanned underwater vehicle (UUV)) can be installed or placed into a pipeline and operated to remove scale from a surface of the pipeline, such as an inner surface. The autonomous robot can use a plasma generator to create an electrolysis reaction that leads to a decrease in current and conductivity of a liquid within the pipeline (such as water). Due to this decrease, a gas bubble can be created and within the gas bubble, as a voltage of the plasma generator reaches a breakdown voltage of the scale, plasma will be formed to remove the scale due to the ultraviolet (UV) radiation, active species, and acoustic wave energy that is created.

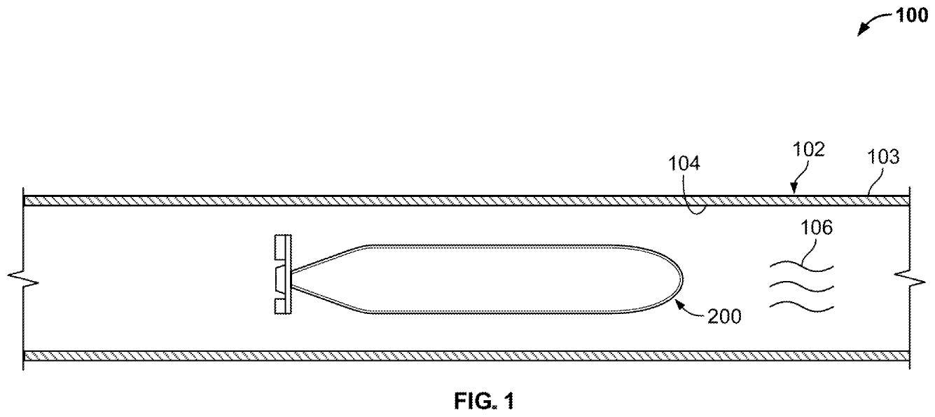

FIG. 1 is a schematic diagram of an example implementation of a pipeline scale removal system 100 according to the present disclosure. The example implementations of the pipeline scale removal system 100 includes a pipeline 102 (or at least a portion thereof) that carries a fluid 106 (for example, a liquid or multi-phase fluid that includes at least some water, whether it is freshwater or brine) between two or more locations. In this example of the pipeline scale removal system 100, the fluid 106 can be water or any other conducting fluid. In some aspects, the pipeline 102 carries produced water 106 from one or more hydrocarbon or water wells. Pipeline 102 can be positioned on a terranean surface; however, alternatively, at least a portion of the pipeline 102 can be positioned or buried under the terranean surface. Alternative implementations include the pipeline 102 that extends at least partially under a body of water, such as a lake, gulf, ocean, river, or otherwise.

As shown in this example, scale 104 is formed on an inner surface 103 of the pipeline 102. Common scales 104 encountered include carbonate, sulfate, silicates, calcium phosphate, and alumina silicates. The formation of such scale 104 can have significant impact on operation of the pipeline 102 by, for example, increasing a pressure drop per unit length of the pipeline 102 thereby increasing pumping costs to move the fluid 106 therethrough. Scale 104 effectively decreases a cross-sectional area of the pipeline 102, thereby constricting flow of the fluid 106 through the pipeline 102 among other problems caused by the scale 104.

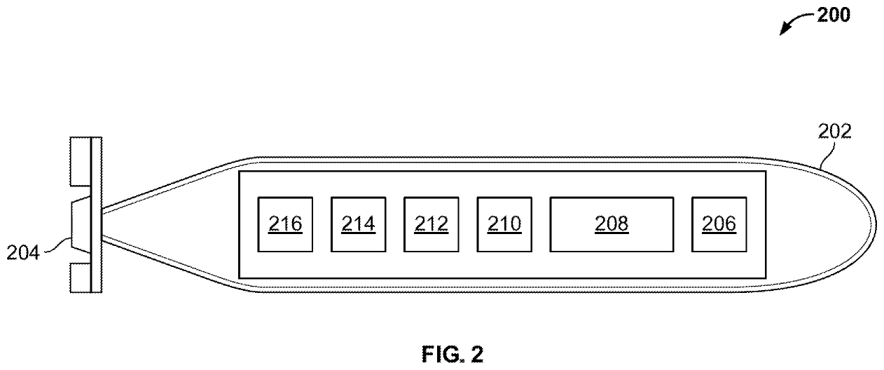

As shown, the autonomous robot 200 can be placed within the pipeline 102 to move through the fluid 106 (either autonomously, semi-autonomously, or under control of a remote control system outside of the pipeline 102. Turning to FIG. 2, this figure is a schematic diagram of an example implementation of the autonomous robot 200. As shown, autonomous robot 200 includes a housing or body 202 that, in some aspects, can be streamlined to move through the fluid 106 while minimizing a drag force on the autonomous robot 200. In this example, propellers 204 can be powered to move the body 202 through the fluid 106. Although shown as outboard propellors 204, other types of propellors such as impellors or inboard propellors, can be used to move the autonomous robot 200 through the fluid 106 untethered to any other device or apparatus.

FIG. 2 also shows a block diagram of components of the autonomous robot 200 that are enclosed (at least partially if not fully) within the body 202. Such components include a controller 206, a scale removal sub-assembly (or “sub”) 208, a voltage generator 210, a flow turbine 212, a power source 214, and a motor 216. Although shown in this example implementation, other implements of an autonomous robot according to the present disclosure may not include each of these components or may include additional components not shown here.

The controller 206, in some aspects, is a microprocessor-based controller (or ASIC controller) that includes one or more hardware processors communicably coupled to non-transitory, tangible memory that stores control instructions in software or firmware. Thus, controller 206 can be pre-programmed to control operations of the components of the autonomous robot 200, and generally, the autonomous robot 200 itself in an autonomous manner (for example, without further instructions or commands provided by a control system external to the autonomous robot 200. Alternatively, the controller 206 can include a communication module that enables bi-directional communication between the autonomous robot 200 and a remotely situated control system or uni-directional communication from the remotely situated control system and the autonomous robot 200 (through the controller 206). Such bi-or uni-directional communication can include commands sent to the controller 206 by a human operator to control operation of the autonomous robot 200.

The scale removal sub 208, in this example, can include or more plasma tools that are operable to remove the scale 104 from the inner surface 103 of the pipeline 102. For example, the scale removal sub 208 can operate to initiate plasma discharge inside the fluid 106 to remove scale 104 from through multiple removal actions such as acoustic waves, reactive species, and UV radiation. The scale removal sub 208, in some aspects, can be a self-autonomous device powered by, for example, the power source 214, the flow turbine 212, or a combination of both. During operation, the scale removal sub 208 generates a pulsed discharge to generate plasma. The scale removal sub 208 includes a high voltage (for example, between 400-800 volts) electrode, while the pipeline 102, itself, acts as a ground electrode. During operation of the scale removal sub 208, formation of a gas bubble inside the high-voltage electrode breaks the current and increases the voltage up to the breakdown voltage of the scale 104, which will end with the formation of plasma and strong cavitation. The process can be highly intensive, with one hundred or more breakdowns per second. The multiple actions of plasma-activated species acoustic waves, and UV radiation can facilitate the descaling process to remove the scale 104 from the inner surface 103. The destruction of calcium carbonate (in or as the scale 104) can be especially high due to a local increase in acidic ion concentrations that, together with other plasma effects (acoustic wave energy and UV radiation) can destroy the formed deposits.

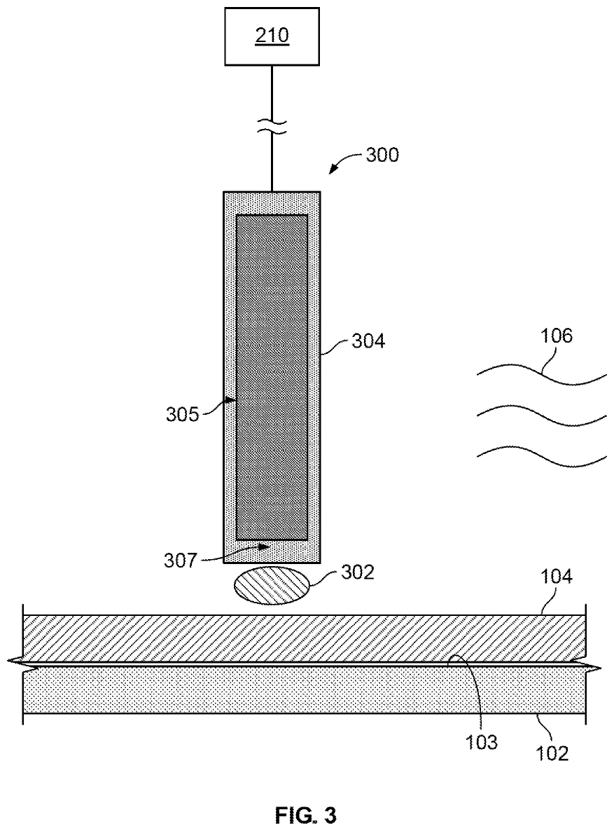

Turning to FIG. 3, this figure shows a schematic diagram of a portion of the scale removal assembly 208 of the autonomous robot 200 according to the present disclosure. As shown in this example, the scale removal sub 208 can be or include a single-electrode plasma tool 300 that is powered by the voltage generator 210 as shown. In this example, the plasma tool 300 includes a capillary tube 304, in which a high-voltage electrode 305 is installed. As noted, the inner surface 103 of the pipeline 102 acts as the ground electrode.

In the example shown in FIG. 3, a space 307 between the bottom cross section of the capillary tube 304 and the bottom part of the electrode 305 can be at least 2 mm. The electrode 305 is connected to the high-voltage generator 210. When the power is on, a fast electrolysis process leads to gas (hydrogen) formation in the space 307, resulting in low conductivity in the circuit and voltage buildup and creation of plasma 302 When the voltage is increased above the breakdown voltage, the breakdown occurs, leading to the creation of reactive species (radicals and ions), acoustic wave formation, and UV radiation.

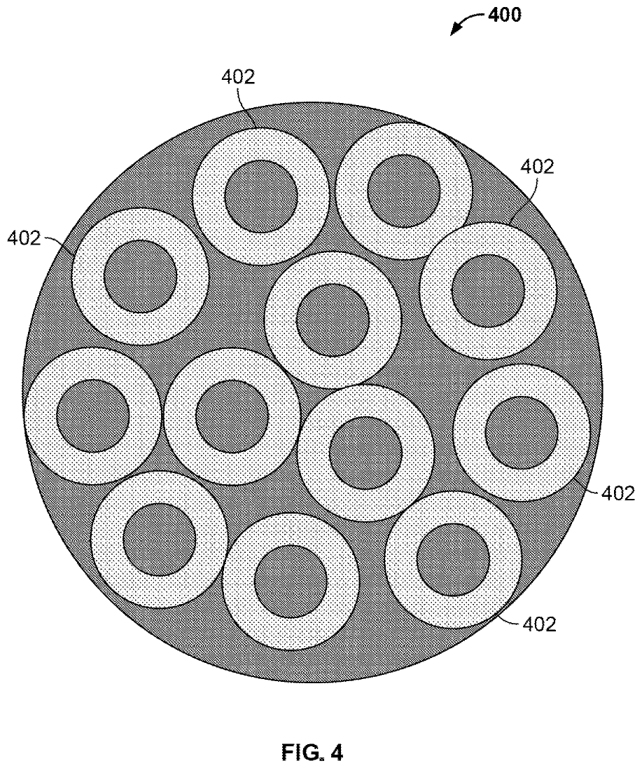

FIG. 4 is a schematic diagram of another example of a portion of the scale removal assembly 208 of the autonomous robot 200 according to the present disclosure. In this example. another example plasma tool 400 is shown. As shown, plasma tool 400 includes an array (multiple) single-electrode plasma tools 402 that are each powered by the voltage generator 210. Each single-electrode plasma tool 402 can be the same as, or similar to, the single-electrode plasma tool 300 shown in FIG. 3.

As shown in this example, the single-electrode plasma tools 402 are arranged in a circular array; however, other implementations of the plasma tool 400 can arrange the single-electrode plasma tools 402 in another type and shape of array. In some aspects, by arranging the electrodes 402 in such an array, the plasma tool 400 can increase an efficiency of the descaling effect by plasma treatment (for example, as compared to the scale removal sub 208 having only the single-electrode plasma tool 300). Each single-electrode plasma tool 402 can produce the plasma, reactive species, and acoustic waves as described with reference to FIG. 3, thereby intensifying the treatment effect in removing scale 104 from the pipeline 102.

Returning to FIG. 2, as further shown in this example implementation, the autonomous robot 200 includes the voltage generator 210, which as described, can operate to generate a high (for example, between 500 and 800 V) voltage for the scale removal sub 208 (and specifically, the plasma tool(s)). The voltage generator 210 received electrical power from one or both of the flow turbine 212 and the power source 214. The power source 214, in this example, can be a rechargeable battery operable to provide stored electrical power to one or more of the controller 206, the scale removal sub 208, the voltage generator 210, and the motor 216 (that drives the propellors 204). The power source 214, as a rechargeable battery, for example, can be recharged when the autonomous robot 200 is not in operation (for example, is removed from the pipeline 102).

Alternatively or additionally, the power source 214 can be charged or re-charged by the flow turbine 212, which operated to convert movement of the fluid 106 to electrical power. The electrical power generated by the flow turbine 212 can be provided directly to one or more of the controller 206, the scale removal sub 208, the voltage generator 210, or the motor 216. However, electrical power generated by the flow turbine 212 can also be provided indirectly to one or more of the controller 206, the scale removal sub 208, the voltage generator 210, or the motor 216 by using such electrical power to charge the power source 214 (which then provides stored electrical power directly to such components). Movement of the fluid 106 through the flow turbine 212 can be generated by circulation (natural or forced) of the fluid 116 within the pipeline 102 or by movement of the autonomous robot 200 through still fluid 106 in the pipeline 102. In some aspects, the autonomous robot 200 can be operated to move against a flow direction of the fluid 106 to maximize a flow rate of the fluid 106 through the flow turbine 212 (to maximize generated electrical power).

In an example operation of the autonomous robot 200, the autonomous robot 200 can be moved through the fluid 106 in the pipeline 102 by operation of the motor 216 which drives the propellors 204. In some aspects, the controller 206 can autonomously control the motor 216 (for example, to turn off or on or control a speed or frequency of the motor 216) to drive the propellors 204 at a constant or variable speed. In some aspects, the flow turbine 212 can provide electrical power to the motor 216 as the autonomous robot 200 moves through the fluid 106; alternatively the power source 214 can provide electrical power to the motor 216 as the autonomous robot 200 moves through the fluid 106. In some aspects, the controller 206 can select which power device (the flow turbine 212 or the power source 214) can drive the motor 216, such as based on a charge amount of the power source 214, a flow rate of the fluid 106 within the pipeline 102, or other criteria. When not driving the motor 216, for instance, the flow turbine 212 can provide power to charge the power source 214.

As the autonomous robot 200 is moving through the fluid 106 in the pipeline 102 (or even when the autonomous robot 200 is not moving in the pipeline 102), the voltage generator 210 can be operated (for example, by the controller 206 with power from the power source 214, the flow turbine 212, or both) to provide high voltage power to the scale removal sub 208. In turn, one or more plasma tools (such as plasma tool 300 or plasma tool 400) can be operated with the high voltage power to generate plasma 302. For instance, as described, the generated plasma 302 can be created by fast electrolysis process that leads to gas (hydrogen) formation, resulting in low conductivity in the circuit and voltage buildup. When the voltage is increased above the breakdown voltage, the breakdown occurs, leading to the creation of reactive species (radicals and ions), acoustic wave formation, and UV radiation. In combination, the creation of reactive species (radicals and ions), acoustic wave formation, and UV radiation destroys the scale 104 formed in the pipeline 102.

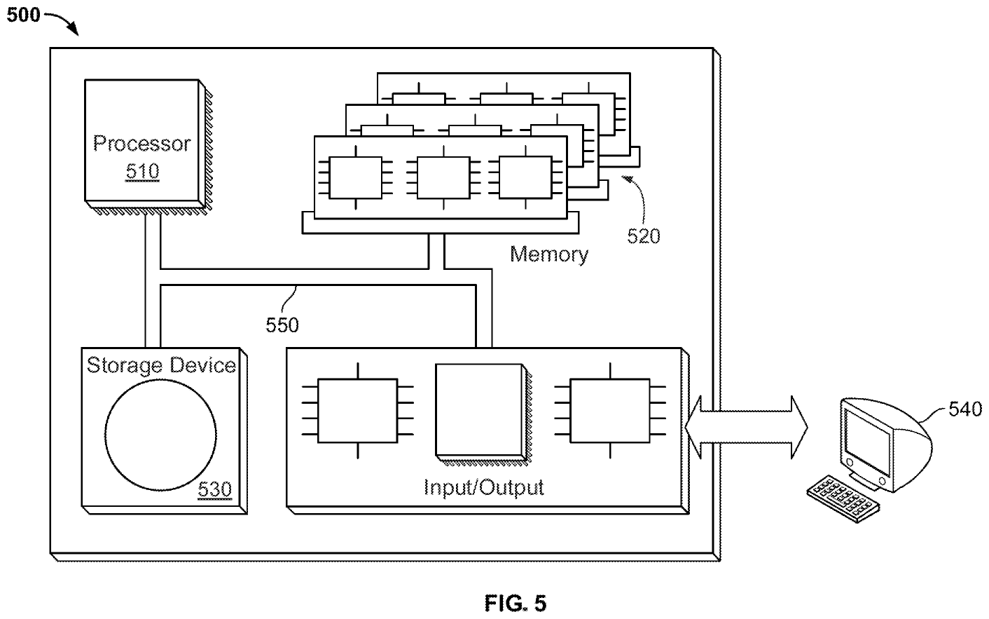

FIG. 5 is a schematic illustration of an example controller 500 (or control system) for controlling operations of a pipeline scale removal system according to the present disclosure. For example, the controller 500 may include or be part of the controller 206 shown in FIG. 2 for the autonomous robot 200. The controller 500 is intended to include various forms of digital computers, such as printed circuit boards (PCB), processors, digital circuitry, or otherwise parts of a biocide testing system. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output device 540. Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the controller 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output device 540 provides input/output operations for the controller 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A pipeline scale removal system, comprising:
a pipeline that carries a liquid and includes scale formed on an inner surface of the pipeline; and
at least one autonomous robot configured to move through the liquid in the pipeline, the at least one autonomous robot comprising:
a housing;
a propulsion system that comprises a power source and a motor, the propulsion system configured to move the housing through the liquid in the pipeline;
a flow turbine coupled to the power source and configured to generate electrical power based on a flow of the liquid through the flow turbine as the housing moved through the liquid in the pipeline; and
a scale removal sub-assembly comprising a plasma tool configured to generate plasma near the scale to remove at least a portion of the scale from the inner surface of the pipeline.

2. The pipeline scale removal system of claim 1, wherein the plasma tool comprises at least one high voltage electrode.

3. The pipeline scale removal system of claim 2, wherein the at least one high voltage electrode comprises a capillary tube electrode.

4. The pipeline scale removal system of claim 2, wherein the at least one high voltage electrode comprises an array of a plurality of high voltage electrodes.

5. The pipeline scale removal system of claim 2, wherein the at least one autonomous robot further comprises a high voltage generator coupled to the at least one high voltage electrode and the power source.

6. The pipeline scale removal system of claim 2, wherein the plasma tool is configured to generate plasma at a voltage above a breakdown voltage of the scale to generate acoustic wave energy and UV radiation to remove the portion of the scale from the inner surface of the pipeline.

7. The pipeline scale removal system of claim 1, wherein the power source comprises a rechargeable battery.

8. A method for removing scale, comprising:
positioning at least one autonomous robot in a pipeline that carries a liquid and comprises scale formed on an inner surface of the pipeline, the at least one autonomous robot comprising:
a housing;
a propulsion system that comprises a power source and a motor;
a flow turbine coupled to the power source and configured to generate electrical power; and
a scale removal sub-assembly comprising a plasma tool configured to generate plasma;
propelling the housing through the liquid in the pipeline with the propulsion system;
operating the plasma tool of the scale removal sub-assembly to generate the plasma near the scale; and
removing, with the plasma, at least a portion of the scale from the inner surface of the pipeline.

9. The method of claim 8, further comprising:
flowing the liquid through the flow turbine; and
generating electrical power with the flow turbine based on the flow of the liquid through the flow turbine as the housing is propelled through the liquid in the pipeline.

10. The method of claim 9, further comprising providing the generated electrical power to at least one of the power source or the motor as the housing is propelled through the liquid in the pipeline.

11. The method of claim 8, wherein operating the plasma tool comprises operating at least one high voltage electrode to remove the portion of the scale.

12. The method of claim 11, wherein operating the at least one high voltage electrode comprises operating a capillary tube electrode to remove the portion of the scale.

13. The method of claim 11, wherein operating the at least one high voltage electrode comprises operating an array of high voltage electrodes to remove the portion of the scale.

14. The method of claim 11, further comprising:
providing power to a high voltage generator of the autonomous robot from the power source; and
powering the at least one high voltage electrode with the high voltage generator.

15. The method of claim 11, wherein operating the plasma tool comprises:
operating the plasma tool to generate plasma at a voltage above a breakdown voltage of the scale; and
based on the voltage above the breakdown voltage of the scale, generating acoustic wave energy and UV radiation to remove the portion of the scale.

16. An autonomous robot for descaling a pipeline, comprising:
a streamlined housing;
a propulsion system at least partially enclosed in the streamlined housing and comprising a power source and a motor, the propulsion system configured to move the housing through a pipeline that comprises scale;
a flow turbine coupled to the power source and configured to generate electrical power based on a flow of water in the pipeline through the flow turbine as the housing moved through the liquid in the pipeline; and
a scale removal sub-assembly comprising a plasma tool configured to generate plasma near the scale to remove at least a portion of the scale from an inner surface of the pipeline.

17. The autonomous robot of claim 16, wherein the plasma tool comprises at least one high voltage electrode.

18. The autonomous robot of claim 17, wherein the at least one high voltage electrode comprises a capillary tube electrode.

19. The autonomous robot of claim 17, wherein the at least one high voltage electrode comprises an array of a plurality of high voltage electrodes.

20. The autonomous robot of claim 17, wherein the at least one autonomous robot further comprises a high voltage generator coupled to the at least one high voltage electrode and the power source.

21. The autonomous robot of claim 17, wherein the plasma tool is configured to generate plasma at a voltage above a breakdown voltage of the scale to generate acoustic wave energy and UV radiation to remove the portion of the scale from the inner surface of the pipeline.

22. The autonomous robot of claim 16, wherein the power source comprises a rechargeable battery.
